(19) United States
(12) Patent Application Publication
(10) Pub. No.: US 2014/0344323 A1
(43) Pub. Date: Nov. 20, 2014

(54) STATE-BASED CONFIGURATION MANAGEMENT FOR DISTRIBUTED SYSTEMS

(71) Applicant: Reactor8 Inc., Palo Alto, CA (US)

(72) Inventors: Richard N. Pelavin, Palo Alto, CA (US); Nate D'Amico, Woodside, CA (US)

(73) Assignee: Reactor8 Inc., Palo Alto, CA (US)

(21) Appl. No.: 14/215,300

(22) Filed: Mar. 17, 2014

Related U.S. Application Data
(60) Provisional application No. 61/786,463, filed on Mar. 15, 2013.
(60) Provisional application No. 61/786,475, filed on Mar. 15, 2013.

(51) Int. Cl. H04L 29/08

(52) U.S. Cl. CPC H04L 67/32
USPC 709/201

(57) ABSTRACT

An electronic system is provided for facilitating configuration management of a service or application distributed over a plurality of nodes that can be in single datacenter or network or span multiple ones The system includes a receiver for receiving a system model, a reasoner, and a workflow engine. The reasoner automatically processes the system model received by the receiver to produce an executable plan for the distributed service. The workflow engine includes a temporal sequencer for dispatching commands to the nodes to carry out the executable plan in a temporally coordinated manner, thereby providing the distributed service. Also provided is a method for facilitating configuration management of a distributed service.

### CROSS REFERENCE TO RELATED APPLICATIONS

This application claims priority to U.S. Provisional Application Ser. No. 61/786,463, entitled “Extending the State-Based System Management Configuration Approach for Clusters, Distributed Applications and Incremental Service Provisioning,” and to U.S. Provisional Application Ser. No. 61/786,475, entitled “Platform for Ranking, Listing & Compensating IT Community Participants,” both filed on Mar. 15, 2013, by inventors Richard Pelavin and Nate D'Amico, the disclosures of which are incorporated by reference in their entireties.

### BACKGROUND OF THE INVENTION

The invention relates generally to state-based configuration management systems applied to devices that can be found in a datacenter or network. More specifically, the invention relates to system management that fully or partially automates configuration or management tasks or actions for services or applications, e.g., install, configure, deploy, scale or upgrade, through an executable plan. The plan may be executed when the components span a plurality of nodes.

Datacenters and networks include interconnected computing devices that communicate and otherwise pass data with each other. Any of a number of devices may serve as nodes that originate, route and terminate data. These can include nodes that are servers, network elements, storage devices, and client machines such as personal computers. The nodes may also take different forms that include virtual or cloud instances, operating system containers as well as physical devices.

The state-based approach to system configuration management has been gaining traction. These approaches center on having the system administrator specify the desired state of a system and the use of automation software that “converges” from the current state to the desired state if possible. These state-based systems have been replacing the earlier approaches which focus on having the administrator provide scripts or procedural workflow that detail the configuration steps to execute.

Current state-based configuration management systems are deficient in that they generally have a “node-centric” design. A node-centric approach provides no coordination mechanism to order configuration temporally across nodes. In order to handle distributed applications or clustered services, these systems require ad-hoc and deployment-specific enhancements, or additional integration, such as separate “run book” style workflow systems. In other words, such an approach typically suffers from rigid scripting problems that may occur when a workflow is tailored specifically to a particular application topology. Another problem with this a node-centric viewpoint is that current systems “converge the whole node.” As a result, difficulties arise when system administrators want to manage multiple tenants or services sharing a node.

Thus, there is a need to provide solutions to the above-discussed problems associated with the node-centric focused configuration management systems.

### SUMMARY OF THE INVENTION

An electronic system is provided for facilitating configuration management of a service distributed over a plurality of nodes that exist or are created in one or more datacenters or networks. These nodes can refer to devices such as servers, network elements and storage units. The system includes a receiver for receiving a system model, a reasoner, and a workflow engine. The receiver may receive the model in a plurality of serialized text formats. The reasoner automatically processes the system model received by the receiver to produce an executable plan for the distributed service. The executable plan can be produced in a plurality of serialized text formats. The workflow engine includes a temporal sequencer for dispatching commands to the nodes to carry out the executable plan in a temporally coordinated manner, thereby providing the distributed service.

Typically, the system model is comprised of semantic constructs that include a component-level construct and service-level construct. For example, the service-level construct may be represented by a service-level domain specific language (S-DSL) describing a desired system state of a distributed application or service, and a component-level construct may be described by a component-level domain specific language (C-DSL) describing a plurality of component types and their invariant or conditional properties.

Components described by the C-DSL may include, for example, a web server, a database server or its databases or users' configuration, a switching or routing function, a storage device service, a computer operating system service. The C-DSL may further describe attribute variables used to parameterize the components, how each component is mapped to node-level constructs, and invariants applicable to the component's behavior and relationship to other components.

Optionally, the workflow engine may further comprise a temporal sequencer and a variable propagator that coordinate and update the attribute variables as their values are obtained. The temporal sequencer and the variable propagator may operate concurrently, thereby generating a dynamic variable that may change as the distributed service is provided. Further optionally, the invention may provide for an internode communicator operatively connected to the work flow engine. Third-party node agents may be operatively connected to the internode communicator.

In any case, the nodes may be distributed across different geographic regions or different data centers and exist in one or more networks. In some cases, at least one node may be a multitenant node, on which a plurality of service or application instances may run.

Also provided is a method for facilitating configuration management of a service distributed over a plurality of nodes that form a datacenter or network. The method involves first receiving a system model. The system model is automatically processed to produce an executable plan for the distributed service. Then, electronic commands are dispatched to the nodes to carry out the executable plan in a temporally coordinated manner. As a result, the distributed service is provided.

Other embodiments of the invention will be apparent to those of ordinary skill in the art in view of the disclosure contained herein.

### BRIEF DESCRIPTION OF THE DRAWINGS

FIG. 1 is a flow chart that depicts an embodiment of the inventive system that provides for automatic generation and execution of executable workflow from a system model.

FIG. 2 depicts an exemplary module of the inventive component invariant model written in C-DSL that represents an application server.

FIG. 3 depicts an exemplary module of the inventive component invariant model written in C-DSL that represents a MySQL server.

FIG. 4 depicts an exemplary module of the inventive component invariant model written in C-DSL that represents a Postgresql server.

FIG. 5 depicts an exemplary service template of the invention for a Hadoop Cluster written in S-DSL.

FIG. 6 depicts an exemplary module of the inventive component invariant model written in C-DSL called forth by the service template depicted in FIG. 5.

### DETAILED DESCRIPTION OF THE INVENTION

### Definitions and Overview

Before describing the invention in detail, it is to be understood that the invention is not generally limited to specific electronic formats or types of platforms, as such may vary. It is also to be understood that the terminology used herein is intended to describe particular embodiments only, and is not intended to be limiting.

Furthermore, as used in this specification and the appended claims, the singular article forms “a,” “an,” and “the” include both singular and plural referents unless the context clearly dictates otherwise. Thus, for example, reference to “a node” includes a plurality of nodes as well as a single node, reference to a “model” include one or more models, reference to “a plan” includes a single plan as well as a collection of plans, and the like.

In this specification and in the claims that follow, reference is made to a number of terms that are defined to have the following meanings, unless the context in which they are employed clearly indicates otherwise:

The term “electronic” and the like are used in their ordinary sense and relate to structures, e.g., semiconductor microstructures, that provide controlled conduction of charge carriers, e.g., electrons and holes. For example, the term “electronic system” may refer to a system whose operation involves controlled conduction of electrons in a digital and/or analog manner.

The term “executable plan” is used herein to describe a structure that provides the temporal ordering and attribute value coordination for a plan that deploys, upgrades, scales, tears down, or otherwise provides a service. An executable plan provides all the detail necessary to carry out operations on a node's operating system. An executable plan can have a nested or hierarchical structure or be flat. An executable plan may contain one or more manual steps. An executable plan can be associated with a service template which serves to provide deployment and management functions for the corresponding service.

The term “internet” is used herein in its ordinary sense and refers to an interconnected system of networks that connect computers around the world via the TCP/IP and/or other protocols. Unless the context of its usage clearly indicates otherwise, the term “web” is generally used in a synonymous manner with the term “internet.”

The term “node” is used in its ordinary computer networking sense to refer to a connection point, a redistribution point or a communication endpoint, i.e., a computer entity that is deployed or staged. Typically, a node is a computer entity having an operating system that is realized in a datacenter or network and can take form as a cloud instance, virtual machine, physical machine, operating system container, network element or storage device. Nodes may, for example, be clients, servers or peers.

As a related matter, the term “logical node” refers to a template or blueprint that, once instantiated, becomes a node.

The term “component” is a unit of configuration. Within a node there are one or more components, e.g., a Linux user, software and other items such as NTP, Apache, Hadoop Namenode, Mysql Server, MySQL client, etc. Components are designed to encapsulate configuration management entities such as those written in Puppet, Chef, SaltStack, Bash, etc. Each component has a “component type.” In some instance, different components can be of the same type, e.g., a plurality of MySQL clients.

A “component instance” has a “component type” and appears on a logical node in a service template. For example, if two component instances appear on the same logical node, then two corresponding components are instantiated on the same node when the service template is instantiated.

The term “component invariant model” is used herein to refer to a set of component types. For each component type, the component invariant model also includes required and optional attributes. Optionally, constraints on attribute values are provided as well. Further optionally, the component invariant model may set forth constraints on how component types may connect and interact with each other.

The term “service” is used herein to refer to an application, a management service, an application's supporting service, a network service, or a storage service, which may include one or more interconnected and interacting components on one of more nodes. The nodes associated with a service can be in a single datacenter or network or can span multiple datacenters and networks.

The term “service template,” which can be interchangeably used with the term “assembly template,” is used to describe a blueprint that, once instantiated, manifests as a service. For example, the template may capture the structure and topology of a service. In addition, a service template contains one or more logical nodes. When a service template is instantiated, each of its logical nodes also becomes instantiated as a node.

The term “attribute” is used herein to describe a property of an entity or object. Each attribute has a set of legal values that can be assigned to it. For example, logical nodes, component types, component instances, and service templates can each have attributes. A component instance inherits its attributes from its component type.

The term “workflow engine” is used to refer to system management software that can follow an executable plan to deploy or manage a service.

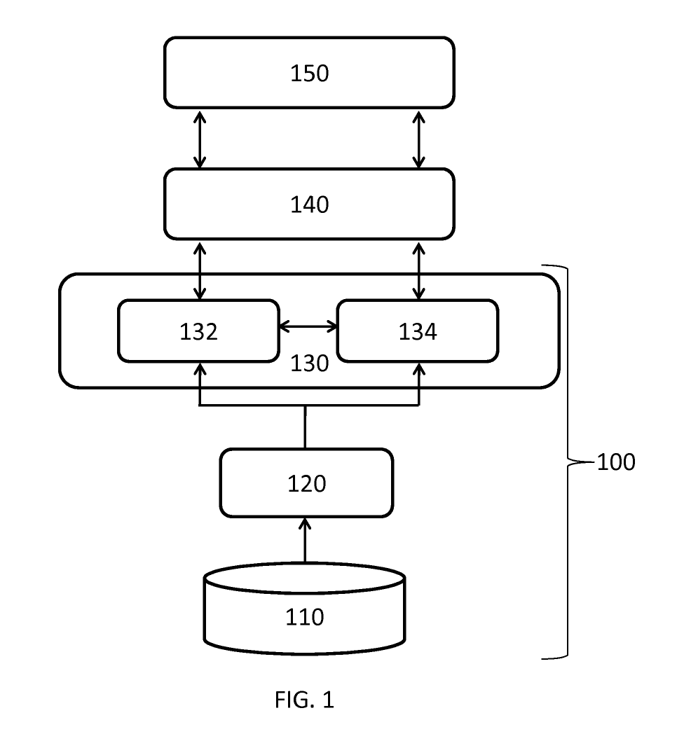

In a first embodiment, as shown in FIG. 1, the invention provides an electronic system 100 for facilitating configuration management of a service distributed over a plurality of nodes that form a datacenter or network. The system includes a receiver 110 for receiving a system model, a reasoner 120, and a workflow engine 130. The system model may be provided in a plurality of serialized text formats, e.g., JSON, YAML or XML. The reasoner 120 automatically processes the system model to produce an executable plan for the service, which may be distributed across networks that span different geographic regions or datacenters at a localized region. The workflow engine 130 may manifest as subfunctions: as a temporal sequencer 132 for dispatching commands to the nodes to carry out the executable plan in a temporally coordinated manner, thereby providing the distributed service; and as a variable propagation engine 134.

In general, the system model may be comprised of a plurality of constructs that may generally be classified as either component-level or service-level. For example, a component-level construct may set forth a component-invariant model for a plurality of components. Such a construct may be represented by a component-level domain-specific language (C-DSL). In general, component-level constructs are typically written in a manner so as to allow for their facile reuse.

Examples of items that may be treated as components include, but are not limited to: web servers, e.g., Apache, Nginx, and Tomcat; database servers and services, e.g., MySQL Master, MySQL Slave, and SQL Server, etc.; distributed storage and processing tool services, Hadoop Namenode, Hadoop Datanode, and Zookeeper Quorum Member; miscellaneous systems, e.g., Linux User and Secure Shell Access; and network functions (vlans, access control lists, load balancing rules, switching and routing functions)

C-DSL may also specify: attributes used to parameterize components; default values for these attributes; and invariants that apply to the component regardless to where it is deployed. These invariants can refer to properties of the component or relations that hold between two or more components. These invariants can also have conditions of applicability applied to them.

Service-level constructs, on the other hand, may set forth a service template. The service template may include, for example, a description of how each component gets mapped to the logical nodes in the service template, a description of how the components in the service template are connected and interrelated, and attribute value assignments. Such constructs may be represented by a service-level domain-specific language (S-DSL).

In other words, the system model typically includes one or more service templates and a component invariant model that includes component types for each component instance appearing in one or more of the service templates

The reasoner 120 is responsible for taking the desired system state, e.g., as expressed in S-DSL, and using invariants, e.g., in C-DSL, to produce an executable plan. The executable plan may be used to coordinate temporally the configuration to achieve system state. In addition, attribute settings of the components may be coordinated as well. For example, the reasoner 120 may ensure that an application component has the host address and port number of a remote database that it needs to connect to.

As shown, the workflow engine 130 may be comprised of a temporal sequencer 132 and a variable propagation engine 134. The sequencer 132 is responsible for temporal coordination and grouping of the lower level configuration actions possibly hierarchically to achieve a system state within an overall task that can be treated as a transaction. The sequencer 132 dispatches commands to execute local configuration changes and receives in return responses generated as a result. In some instances, the sequence 132 may terminate the entire task if any subtask fails. Alternative, a substitute strategy may be carried out to handle subtask failure.

The variable propagation engine 134 is responsible for coordinating the relationship between attribute variables that are used to parameterize the distributed components the make up the system level configuration. The engine 134 maintains a graph that relates the values of variables as opposed to technologies that just maintain relations between components. When the value of a variable is learned, the engine 134 propagates the learned value to related variables, which in turn might lead to further propagation.

Notably, the interaction between the temporal sequencer 132 and the variable propagation engine 134 represents another novel and nonobvious aspect of the invention. As discussed to above, the temporal sequencer 132 is responsible for executing configuration changes, and the variable propagation engine 134 is responsible for setting configuration attribute values. In the inventive approach, the process of enacting configuration changes and the process of setting configuration attribute values are performed concurrently. As a result, the invention provides for dynamic variables, i.e., attribute values that are learned in the midst of execution and used subsequently in later actions.

Typical examples of dynamic variable include: the host address of a virtual or cloud server instance that gets spun up; the volume number of a new mounted block store; and the process identification of a service that gets started.

In contrast, prior art state-based configuration management systems generally require variable values to be set as an initial phase that completes before command execution begins.

When a user wants to start the configuration process, the temporal executor 132 and the variable propagation engine 134 actively communicate with agents on the nodes being controlled using an internode communication channel. The temporal executor 132 and variable propagation engine 134 send requests to the relevant nodes to achieve local configuration state described by requests with a component name and attribute values. Upon successful completion or failure, the nodes send back whether the local configuration changes succeeded plus any values locally generated as a result of configuration changes, i.e. dynamic attribute values.

More specifically, the reasoner 120, temporal executor 132 and variable propagation engine 134 may interact as follows:

The executor 132 temporally arranges the components specified in the S-DSL using the component ordering constraints in the C-DSL to form a partially ordered workflow.

The reasoner 120 also uses the relationship between attribute values captured by the C-DSL specifications to form the attribute value dependency graph, the data structure used by the variable propagation engine. In addition, additional temporal constraints are imposed on the workflow that stem from the principle: if a component c1 requires an attribute value v1 that is dynamically computed, the component c2 that computes v1 must be ordered before c1

Before workflow execution, “static attributes” can be propagated. In some instances, static attributes may be directly input into the S-DSL. Alternatively, they may come from other sources outside the system like an inventory system of the CMDB (configuration management database).

During workflow execution, when dynamic attribute values come back to the workflow engine 130, they get sent to the variable propagation engine 134. The variable propagation engine 134 propagates the learned values to any variable connected in the graph and updates these values and makes them available to the components yet to be executed in the workflow engine. This propagation is recursive and follows the structure of the graph.

The invention is flexible in the types of internode communication channels 140 that can be used in a pluggable type manner. Some examples are: Message Bus Protocols, e.g., AMQP, Stomp, etc.; SSH; SCP; TCP/UDP; Git/ssh, git/https

Communication may be carried out from a centralized location or may be done in a peer-to-peer fashion.

To facilitate peer-to-peer communication, the variable propagation engine may be used to compile an individual executable plan for each node. The individual node-level executable plans may then be initially delivered to each node. Each of these node-level execution plans would instruct the nodes to listen and wait for attributes associated with their components that need input and send messages when they compute attributes linked to components used by others.

Node agents 150 are functions that can each interact with a “third party executor” which can be a node-level configuration agent or an executor that applies parameterized Shell/Bash scripts. Node agents 150 are responsible for receiving a set of sequentially ordered components to “converge” with a set of attributes that parameterize the component configuration logic. The node agent 150 then translates and transfers the components to the third party node-configuration executor. The third party node-configuration executors are responsible for: translating the requests from the agents into actual commands that can be executed on the node's operating system; creating necessary configuration files; performing related tasks; and reporting whether any problems arise during execution. The third party-node configuration executors can be node-level configuration software components that works on languages from Puppet, Chef, SaltStack etc or be a mechanism that parameterizes the Bash scripts.

Node agents are also responsible for making sure that the component configuration logic needed by the third party executors is present on the node. When a configuration request comes into a node agent, the node agent first ensures that all the component logic is present on the node. If any component logic is absent, the node agent may pull from the appropriate remote location one or more files and/or scripts that the third party executor may need to carry out a “component configuration.”

A C-DSL Example

One or more component invariant models may be used, wherein closely related components may be grouped together to form a module. To illustrate, FIG. 4 depicts code 200 that represents a component module. As shown, the component module set forth a section 210 for external references, a section 220 for attributes, a section 230 for requirements, and a section 240 for links.

External reference section 210 describes how the terms used in the invention's DSL get mapped to terms that are used by the underlying node-level configuration mechanism.

Component attribute section 220 identifies a set of attributes that can be used to specialize the behavior of the component.

The requirement section 230 lists other components that must be on the node for the specified one to be executable. The required component can be specified to be ordered earlier than the specified one.

The links section 240 capture other components that a component may depend on, e.g., an application needing a database, a Hadoop datanode needing a namenode, a zookeeper quorum member needing the host addresses of peer quorum members, etc. The component and a dependent one can be on the same node or different nodes.

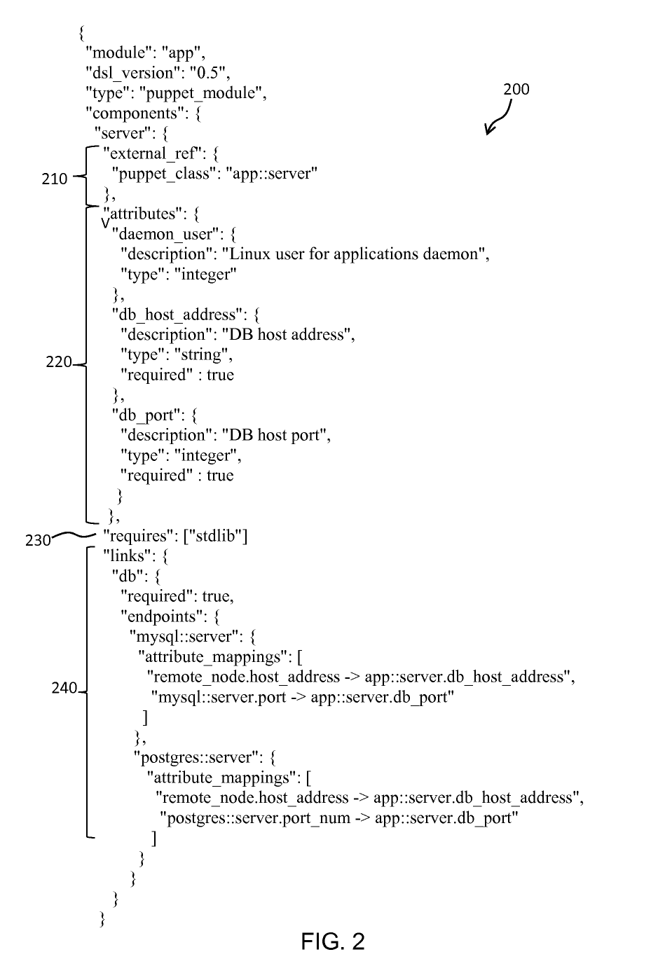

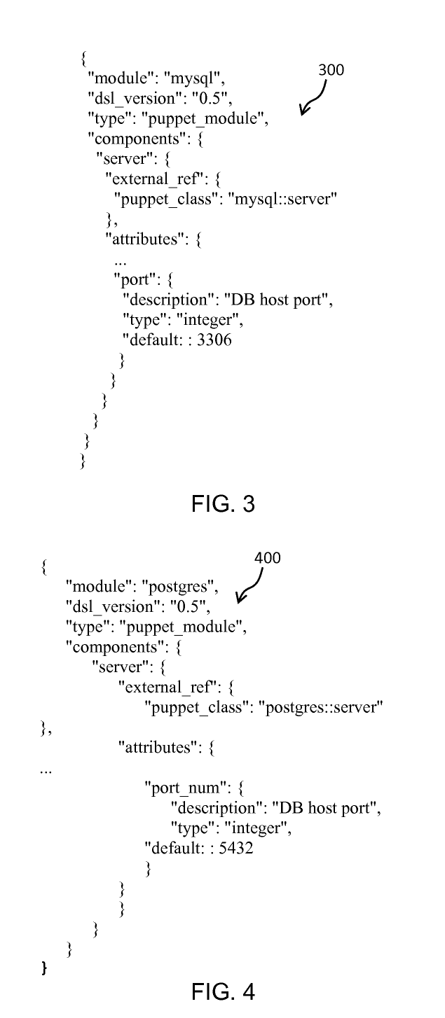

As shown in FIG. 2 the links section refers to a component that is either a Mysql or Postgresql database. A fragment for a Mysql component is 300 shown in FIG. 3. Similarly, a fragment for a Postgresql component 400 is shown in FIG. 4.

Notably, the links section 240 capture not only related components, but also the mapping between the component's attributes and the attributes of the related components. By explicitly capturing this attribute mapping, section 240 allows multiple authors or developers to build components choosing their own namespace for variable names as opposed to needing close coordination on namespace selection. In other words, the invention facilitates loosely coupled development of the various components that make up system configuration. It does not matter that the Postgres module 400 refers to TCP ports as “port_num,” while the Mysql module 300 refers to TCP ports as “port.”

Another novel aspect of the invention is that the relationship between components are invariants that are meant to be applicable in any deployment where they are composed together to form an application or service. For flexibility, these invariants can also have conditions of applicability. This use of invariants contrasts with the other state based approaches where for each cluster/application level specification, the developer must explicitly provide for the associations between components. In contrast, the invention allows for these relationships to be automatically inherited from the component's type description in the component DSL.

A S-DSL Example

The S-DSL can capture the different application topologies and service-mixes that can be constructed to create a cluster, distributed application, service or tenant. A service associated with a Hadoop cluster may, for example, have one or more topologies capturing the different ways that components that represent namenodes, datanodes, jobtrackers, tasktrackers, etc. can be arranged and connected. Server-side and client-side components for Nagios or Ganglia would be present as well when Nagios and Ganglia monitoring is taking place.

The service DSL is specified in terms of service modules which are grouped together as a set of related topologies referred to as “assemblies.” Provided as an example is an assembly consisting of a “master node”, a set of “slave nodes”, and a monitor node. The assembly also captures an HDFS/Mapred cluster running and being monitored by a Nagios server.

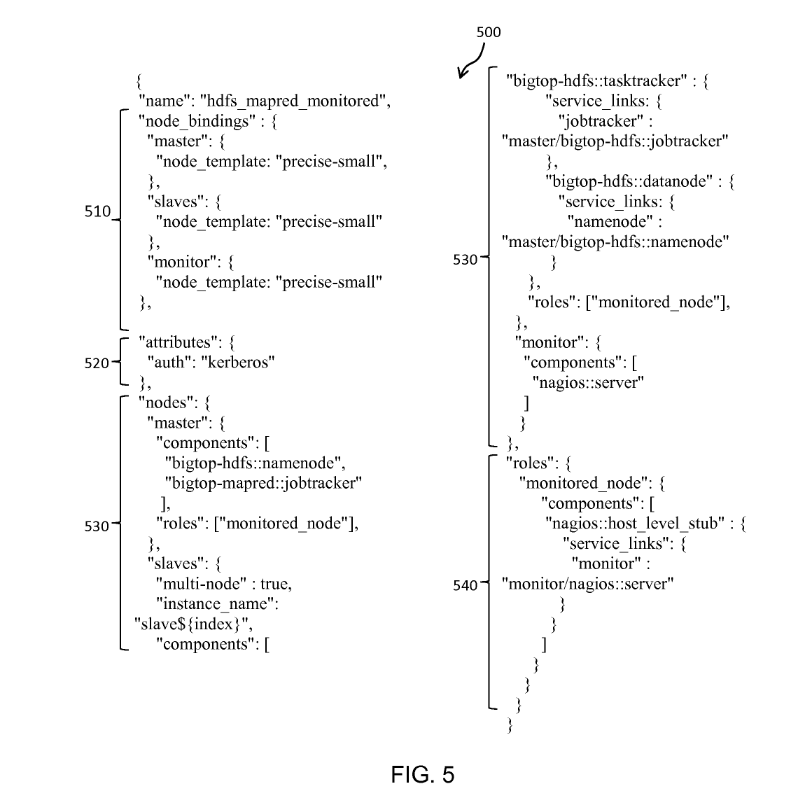

FIG. 5 depicts code 500 that represents an assembly. As shown, the assembly sets forth a section 510 for node bindings, a section 520 for attributes, a section 530 for logical nodes, and a section 540 for roles.

Section 510 describes node bindings, which indicate for each “logical node,” e.g., “master” and “monitor,”, information about or constraints on the actual node that it will be bound to or the one that gets created when an instance of the service described by the assembly is instantiated. These actual nodes can take the form of a physical machine, cloud instance, virtual machine or OS container. As one of the alternatives, section 510 is provided for an EC2 Cloud environment. Bindings to ‘precise-small’ indicate that each node will be created by using an AMI that corresponds to an Ubuntu Precise OS spun up with a small memory size.

Section 520 describes global attributes, which are variables that are accessible by all components in the assembly. As shown, “auth” is a global attribute that indicates the authentication method used by the Hadoop services.

Section 530 describes logical node and groups section, which for each logical node or node group, indicates the components to be put on the node or on each member of the node group, and indicates for each component: default attribute values and service links. As shown, service links indicate how the components are connected across nodes in the assembly or within the same node. These service links reference the C-DSL link defs. The service links under “slaves” captures that on each slave node: a datanode is connected to the namenode on the master node, and a tasktracker is connected the jobtracker on the master node.

Section 540 describes node roles, which provide a way to characterize the logical node or node groups from multiple dimensions. The contents under a role are akin to the contents under a logical node or node group. In the example above, the role “monitored node” is used by any node that is to be monitored by the Nagios server on node “monitor.” In the logical node/group section the “roles” directive indicates what roles a node or node group belong to. All master and slave nodes belong to the “monitored nodes group,” meaning that they all connect to the Nagios server on the “monitored” node.

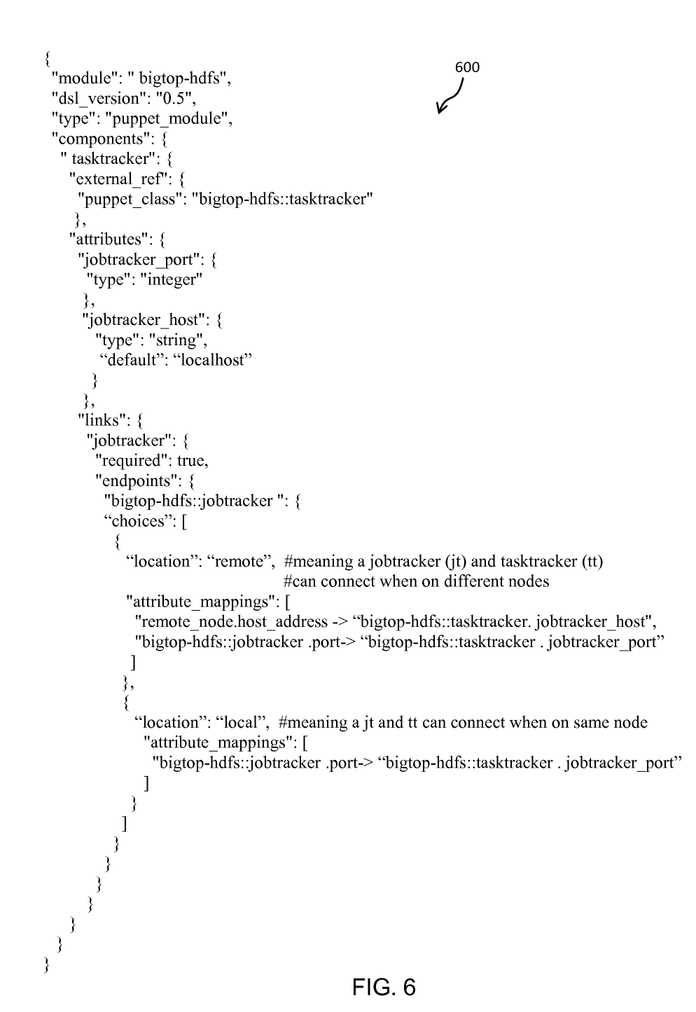

Another module called forth by code 500 is shown in FIG. 6.

By having explicit links between components, representational adequacy is achieved to handle multiple clusters in the same administrative scope; the invention provides sufficient flexibility to indicate what gets connected to what. For example, the invention provides sufficient flexibility to describe an environment with two Nagios servers where for each cluster, some of the components are monitored by one Nagios server and other components by the other. As another example, the invention allows for separate clusters that each has interconnected parts, but also has a shared services, such as a site-wide authentication service or shared logging service.

Another aspect of the invention is having the assembly construct. By having an explicit assembly object that just has the components relevant to one application, the invention provides for facile handling of cases such as multiple applications that share some nodes.

Thus, the inventive system represents an improvement over prior art approaches in any of a number of ways. For example, the invention does not focus on the node as the basic unit. Instead, the invention may treat a cluster, application/service, or tenant as being the basic unit of convergence. In addition, the invention enables the automated generation of the configuration or management of a service as a whole even though it is distributed across a network. Furthermore, an abstraction and pluggable architecture is provided that allows the invention to be extended and tightly integrated with existing “node-centric” systems or workflow systems

As discussed above, the inventive modeling approach shifts the basic unit of convergence away from a node toward an item such as a service, tenant, or whole cluster. This approach allows a much higher degree of reusability of modeled components that can truly be treated as interchangeable building blocks allowing one to think about services in a “layered” or black boxes manner. The “layering” afforded by this approach allows a distributed service to plug into a lower level distributed service it depends on.

The invention also introduces tasks which move the state-based paradigm from being “pull-based” where nodes check in periodically or when triggered to get their full configuration state to also handling “push-based” deployments. A pushed-based approach allows for on-demand provisioning, where an end user at any time can specify a service state to achieve or desired changes. In response, the inventive system converges its infrastructure to achieve the distributed service state under the supervision of a task. By having tasks, the system has the building blocks to treat configuration in a more transactional way.

The inventive approach to modeling services takes an agnostic approach to what the underlying “node-centric” state-based/configuration systems are carrying out work at the node level. These could include state-based configuration systems, language specific solutions such as perl, ruby, python, or more traditional stylized bash/shell scripts.

The invention also provides numerous ways for a community to build, encapsulate and share configuration logic for a wide variety of node-level services. For example, the invention allows a community to build “component configuration logic” that is applicable to a wide range of operating systems. In such a case, it may be typical for the configuration logic for a component to treat multiple operating systems. This invention also leverages node-centric systems by providing a flexible abstraction to interface with agents provided by these technologies and reusing the component configuration logic being developed and shared in the various configuration management communities or within an organization.

Variations of the present invention will be apparent to those of ordinary skill in the art in view of the disclosure contained herein. For example, the invention may be carried out over a plurality of nodes connected via the internet. In addition, it is to be understood that, while the invention has been described in conjunction with the preferred specific embodiments thereof, the foregoing description merely illustrates and does not limit the scope of the invention. Numerous alternatives and equivalents exist which do not depart from the invention set forth above. Other aspects, advantages, and modifications within the scope of the invention will be apparent to those skilled in the art to which the invention pertains.

All patent applications mentioned herein are hereby incorporated by reference in their entireties to the fullest extent not inconsistent with the description set forth above.

What is claimed is:

1. An electronic system for facilitating configuration management of a service distributed over a plurality of nodes that are in one or more datacenters or networks, comprising:
a receiver for receiving a system model;
a reasoner that automatically processes the system model to produce an executable plan for the distributed service; and
a workflow engine comprising a temporal sequencer for dispatching commands to the nodes to carry out the executable plan in a temporally coordinated manner, thereby providing the distributed service.

2. The system of claim 1, wherein the receiver allows for the system model to be received in a plurality of serialized text formats.

3. The system of claim 1, wherein the system model is comprised of semantic constructs that include a component-level construct and a service-level construct.

4. The system of claim 3, wherein the service-level construct is represented by a service-level domain specific language (S-DSL) describing a desired system state of a service that may be distributed, on one node or one of many services on one node.

5. The system of claim 4, wherein the S-DSL further describes how component instances making up the service are assigned to one of more logical nodes.

6. The system of claim 5, wherein the service-level construct comprises a single service template capable of generating multiple copies of the same service without modification.

7. The system of claim 4, wherein the S-DSL further describes specific component instances making up the service that should be interrelated if located on a single logical node and the specific ones that should connect through a network if located on different logical nodes.

8. The system of claim 7, wherein the service-level construct allows for topology changes by just changing connections between components.

9. The system of claim 3, wherein the component-level construct is represented by a component-level domain specific language (C-DSL) describing a plurality of invariant conditional properties of a set of component types.

10. The system of claim 9, wherein the C-DSL further describes attribute variables used to parameterize each component types' behavior, default values for zero or more of the attributes, and whether an attribute's value is required.

11. The system of claim 9, wherein the C-DSL further describes constraints on how component types may connect and interact with each other.

12. The system of claim 9, wherein the C-DSL further describes how attribute values of connected components are interrelated.

13. The systems of claim 4, wherein the workflow engine further comprises a variable propagator that coordinates and updates attribute variables as variable values are obtained.

14. The system of claim 13, wherein the temporal sequencer and the variable propagator operate concurrently and in a coordinated manner to execute the executable plan.

15. The system of claim 1, further comprising an internode communicator operatively connected to the work flow engine.

16. The system of claim 15, further comprising third-party node agents operatively connected to the internode communicator.

17. The system of claim 1, wherein the nodes are distributed across different geographic regions.

18. The system of claim 1, wherein the nodes are distributed across different data centers.

19. The system of claim 1, wherein at least one node is a multitenant node.

20. The system of claim 1, wherein, one or more steps in the executable plan is manually executable.
